(19) United States
(12) Patent Application Publication
(10) Pub. No.: US 2014/0019297 A1
(43) Pub. Date: Jan. 16, 2014

(54) Electronic Commerce System Incorporating Shopping Baskets

(71) Applicants: Przemyslaw Piotr Iskra, Piles (ES); Stephane Tougard, Singapore (SG)

(72) Inventors: Przemyslaw Piotr Iskra, Piles (ES); Stephane Tougard, Singapore (SG)

(73) Assignee: BOOTIC, INC., Palo Alto, CA (US)

(21) Appl. No.: 13/545,490

(22) Filed: Jul. 10, 2012

(51) Int. Cl. G06Q 30/00

(52) U.S. Cl. 705/26.8

(57) ABSTRACT

An interactive system for conducting electronic commerce. The system provides multiple electronic shopping baskets for each user. Each electronic shopping basket has an indication of items 128 currently within the electronic shopping basket, billing 114 and shipment information 112. The system further provides the user means for conducting electronic commerce when the user is not authenticated.

### TECHNICAL FIELD

The present invention relates generally to electronic commerce systems, and more particularly to shopping baskets implemented through an electronic commerce website for business-to-business transaction environments.

### BACKGROUND

Consumers are growing increasingly comfortable with the concept of shopping and purchasing goods online, i.e., over the Internet, with many well known websites displaying various offerings ranging from books and toys to music and countless other consumer goods. Typically, at electronic commerce websites, a number of goods can be selected by the user and added to an electronic shopping basket which stores the selected items for purchase by the user. The items stored in the electronic shopping basket can subsequently be checked out (i.e., purchased) by the user.

Typically, the items can be saved in the user's electronic shopping basket when the user signs off from the electronic commerce website, allowing the user to purchase the items during a subsequent visit to the website. When the user returns to the electronic commerce website, the saved items in the electronic shopping basket are made available for purchase. The above features are made possible only when the user has logged onto the electronic commerce website. To log on to the website, the user is identified by some combination of cookies stored in the user's computer, as well as password authentication.

U.S. Pat. No. 6,629,079, titled “Method and System For Electronic Commerce Using Multiple Roles” issued 30 Sep. 2003, discloses a computer system for conducting electronic commerce. The system provides multiple electronic shopping carts for each user and each electronic shopping cart has an indication of items currently within the electronic cart and billing and shipment information. However, the system only provides the above features when the user has successfully logged in to the electronic commerce website. The system does not provide similar means when the user is not logged in to the electronic commerce website.

U.S. Pat. No. 6,876,977 titled “Shared Shopping Basket Management System” issued 5 Apr. 2005, discloses a computer implemented method for conducting business-to-business electronic commerce over the internet. The method includes the step of providing a website that enables electronic communication with users and including on the website an electronic shopping basket which is selectively actuatable into various states. The website however does not provide such means when the user is not logged in to the website.

Accordingly, there is a need in the art for an electronic shopping model that is adaptable enough to allow users to electronically capture and save items which they wish to purchase even when they are not authenticated by the electronic commerce system. This will provide users the convenience to access the means to electronically saved items for later purchase. Furthermore, other desirable features and characteristics will become apparent from the subsequent detailed description and the appended claims, taken in conjunction with the accompanying drawings and this background of the disclosure.

### SUMMARY OF THE INVENTION

In one aspect of the present invention, there is provided a method in an interactive medium for conducting electronic commerce. The method includes the steps of providing a website which is adapted to communicate electronically with a plurality of remote users; enabling one of the plurality of users to access the website and add items to a non-authenticated electronic shopping basket when the user is not authenticated on the website; and providing on the website a plurality of authenticated electronic shopping baskets which are accessible by the plurality of users after successful authentication. The plurality of users can log on to the website using predefined usernames and passwords. The plurality of users will be allowed access into the website once the usernames and passwords have been authenticated.

In another aspect of the present invention, there is provided a method in an interactive medium for conducting commerce. The method comprising the steps of a user accessing a website for conducting electronic commerce, the user adding items into a non-authenticated electronic shopping basket before he authenticates himself on the website; the user adding items to a plurality of authenticated electronic shopping baskets when he has successfully authenticated himself, whereby the user can select each of the plurality of electronic shopping baskets for adding items.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with a present embodiment.

FIG. 1 illustrates a view of a screenshot of an electronic shopping basket window in accordance with the present embodiment.

FIG. 2 is a flowchart that illustrates the steps of operation of the present embodiment concerning items stored in a non-authenticated electronic shopping basket.

FIG. 3 is a flowchart that illustrates the steps of operation of the present embodiment when there are no items stored in a non-authenticated electronic shopping basket.

FIG. 4 is a flowchart that illustrates the steps of operation of a further embodiment with regards to affecting the status of the items in the authenticated electronic shopping baskets, checking out items and storing items for future use.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

The present embodiment defines providing of electronic shopping baskets for online shopping in an electronic commerce website. The user can store items for a defined period, or manage different electronic shopping baskets when he is logged on to the website. Alternatively he can store items that he will like to purchase for a defined period in a non-authenticated electronic shopping basket provided when he is not logged on to the website.

As used herein, the term “electronic shopping basket” refers generally to an electronic place holder that indicates selections made in an electronic commerce website of goods and services for purchase. Further, an electronic commerce website refers generally to an interface enabling business communication and/or transactions over a publicly accessible communication network such as the internet. Internet-related electronic commerce websites provide mechanisms for buying and selling over the worldwide web.

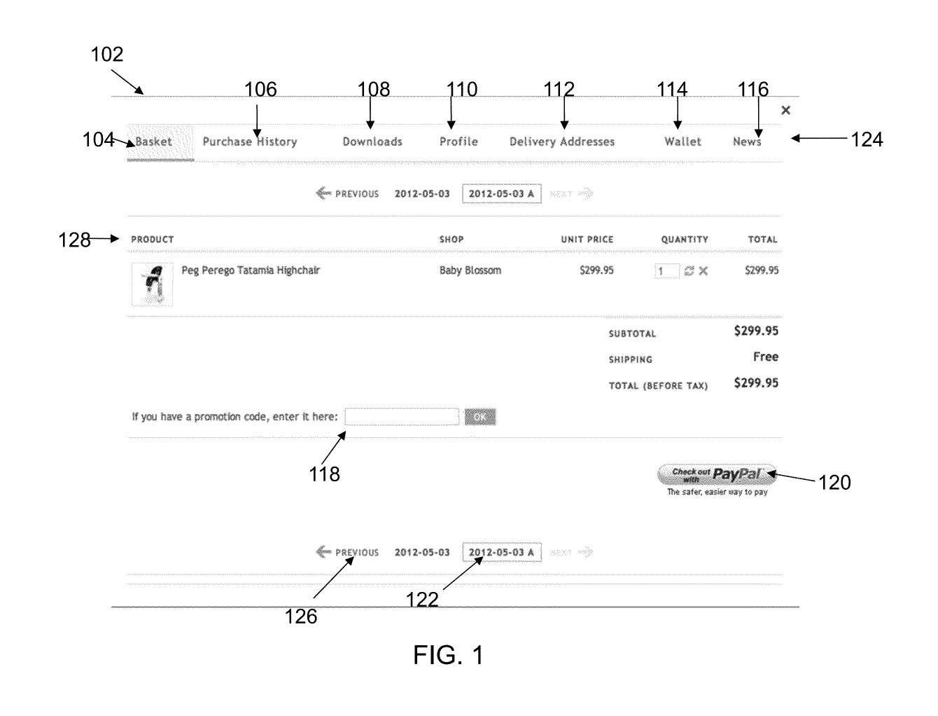

FIG. 1 shows a screenshot 102 of an electronic shopping basket window in accordance with the present embodiment after an authenticated user has added items to be purchased into the electronic shopping basket. The electronic shopping basket window 102 employed consists of a standard buttons tool bar 124. A shopping basket button 104 is provided on the standard buttons tool bar 124 which, when selected, displays the items currently stored in the basket and the total cost required to purchase the items. Other information may be provided by the following buttons which may also be available on the standard buttons tool bar 124: a purchase history button 106 which, when selected, displays items the user previously purchased; a download button 108 which, when selected, displays history of downloaded product information; a profile button 110 which, when selected, displays the identity and contact information of the user; a delivery address button 112 which, when selected, displays the purchased item delivery address; a wallet button 114 which, when selected, displays the amount of credit that is available to the user for making purchase on the electronic commerce website; and a news button 116 which, when selected, displays news on the latest product which is available for purchase on the electronic commerce website. The present embodiment allows a user to select items of interest from the product catalogue, and drag and drop the items of interest into a shopping basket icon in the main electronic commerce website window, automatically adding the details of the item to a user's shopping basket product list 128 in the shopping basket window 102. Further the electronic commerce website includes a mechanism 120 that allows a visitor to complete a sales transaction, for example, by submitting a credit card number, debit card number or the like. Additionally, the shopping basket window 102 provides an entry point 118 for promotion code, if it is available to the user. Each of the buttons can be selected by a single action (e.g. a mouse click). The use of single action to activate the buttons provides ease of use and greatly enhances the experience of conducting the electronic commerce.

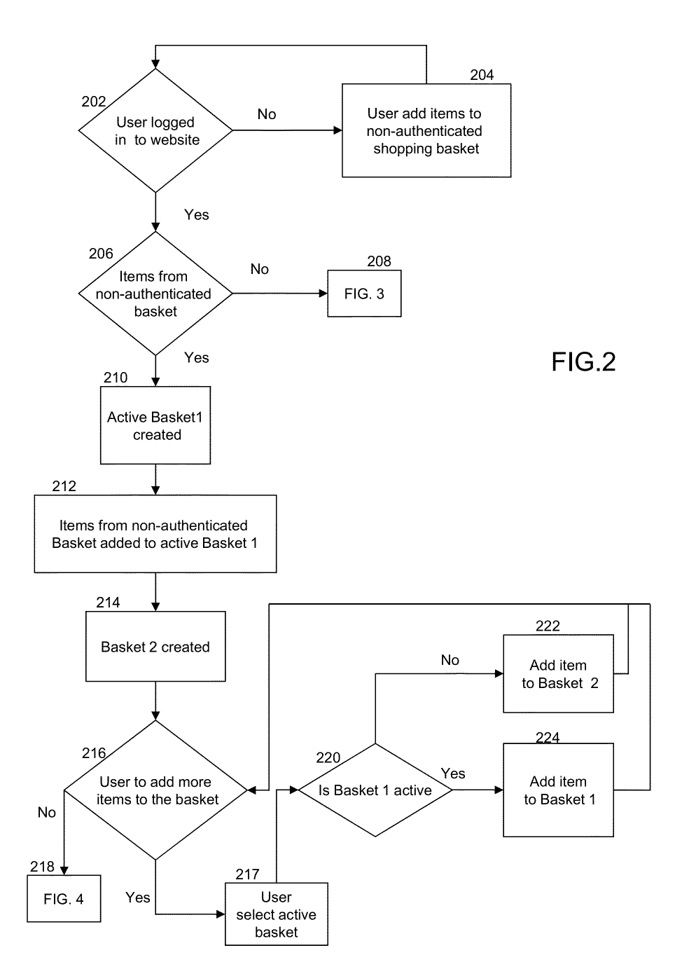

FIG. 2 is a flowchart illustrating the steps of deployment of electronic shopping baskets in an electronic commerce website. When there are stored items in a non-authenticated electronic shopping basket, in step 204, of the electronic commerce website, the present embodiment allows a user to temporarily store items prior to purchasing these items electronically. When a user prior to authenticating himself in an electronic commerce website, found items he would like to purchase, he may store the items in a non-authenticated electronic shopping basket, in step 204, for future purchase. Once the user has successfully logged in to the electronic commerce website, in step 202, by means of a username and password, a first authenticated active electronic shopping basket will be created, in step 210, and items from the non-authenticated basket, in step 204, will be automatically transferred into the active electronic shopping basket, in step 212. Once items are present in the first electronic shopping basket, in step 212, a second authenticated electronic shopping basket will be created, in step 214, for the user. If the authenticated user wants to add further items to the electronic shopping basket, in step 216, the authenticated user will select the active electronic shopping basket, in step 217, and place the desired items into the active electronic shopping basket, in step 222 or step 224.

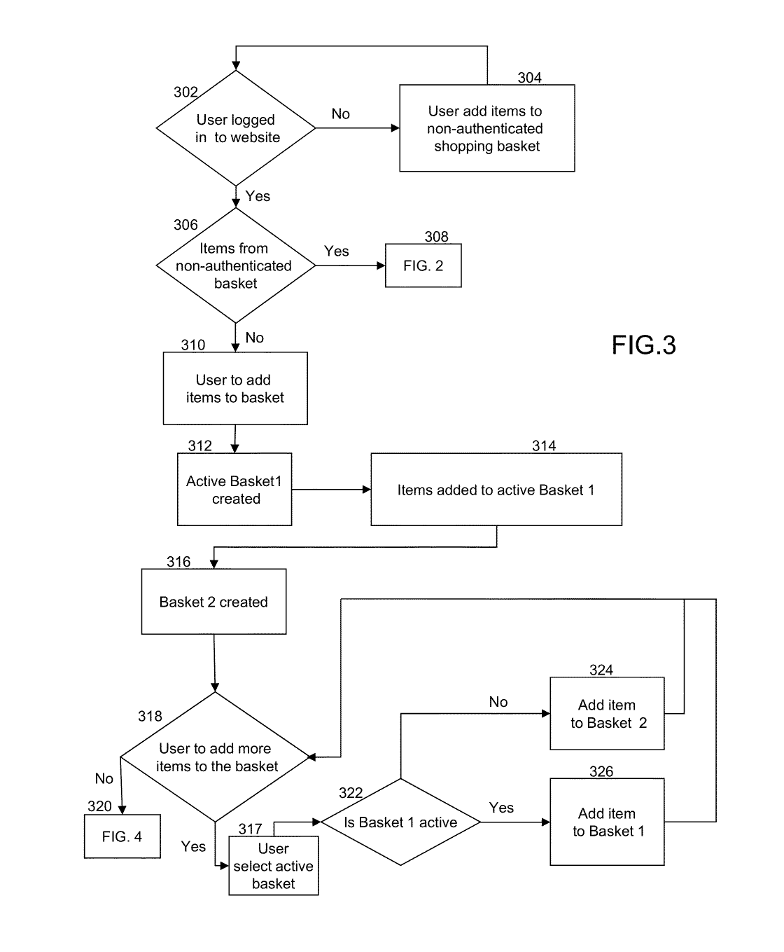

FIG. 3 is a flowchart illustrating the steps of deployment of electronic shopping baskets in an electronic commerce website. There are no stored items in the non-authenticated electronic shopping basket, in step 304, of the electronic commerce website prior to the user logging in to the electronic shopping website. When the authenticated user decides to add items to the electronic shopping basket, in step 310, a first active electronic shopping basket will be made available, in step 312, and the items are added into the active electronic shopping basket, in step 314, while a second electronic shopping basket will be made available to the user, in step 316. At step 318, when there are two electronic shopping baskets available to the authenticated user and the authenticated user wishes to add store more items for future purchase, he may, at step 317, decide which should be his active basket for storing the items in step 324 or 326. Referring to the screenshot 102 of FIG. 1, the authenticated user may choose the active basket by clicking on it 122 or by clicking on the “Previous” or “Next” button 126 using a single action (e.g. a mouse click).

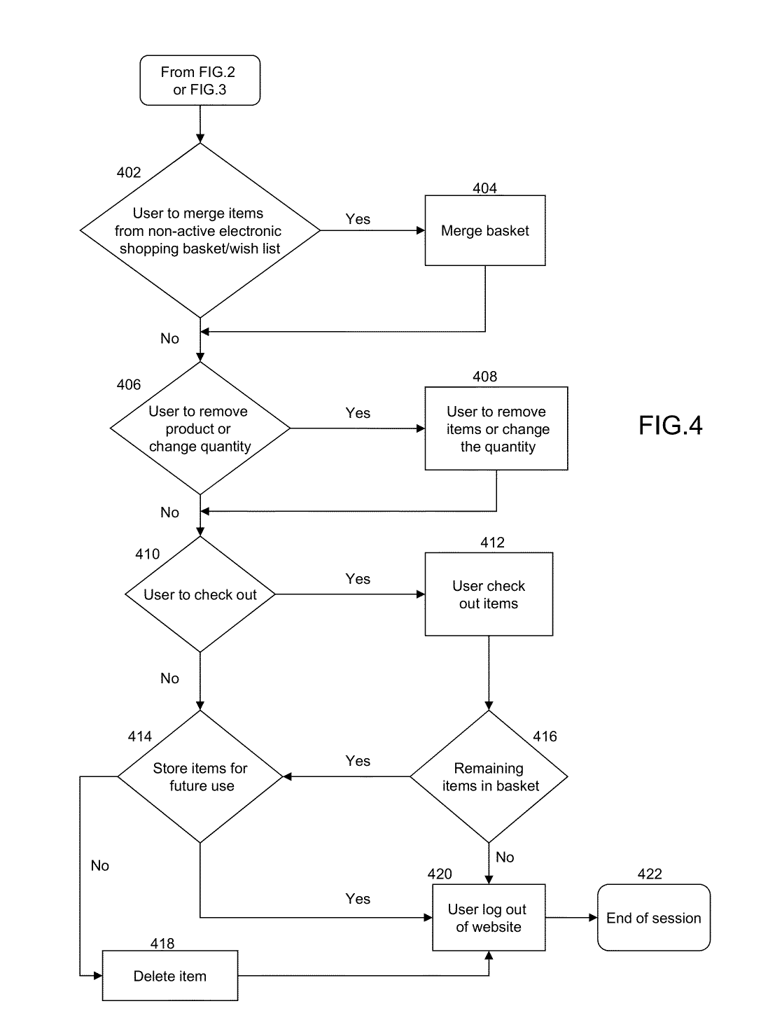

FIG. 4 is a flowchart illustrating the steps of editing the content of an authenticated electronic shopping basket. When the authenticated user does not wish to add more items into the electronic shopping baskets in step 216 of FIG. 2 or step 318 of FIG. 3, the authenticated user can decide, in step 402, if he would like to merge items from the non-active electronic shopping basket or wish list to the active electronic shopping basket, in step 404. Further, the authenticated user can decide, in step 406, if he would like to remove product or change the quantity of the items in the electronic shopping basket, in step 408. The authenticated user, in step 410, can then decide if he wants to check out the items in the electronic basket for purchase, in step 412. Subsequently, in step 416, any remaining items in the electronic shopping basket can be stored for future use, in step 414 or deleted in step 418 before the user log out of the electronic commerce website at step 420.

Embodiments of the present invention allow non-authenticated users in electronic commerce website to store items for later purchase when the users have been successfully authenticated. The embodiments offer the following advantages over conventional electronic commerce websites. For example, a family member of a website user who might not know a password to access the website can first select the items they want to purchase, and once all the items have been selected, the authenticated user can make a consolidated purchase. This is especially useful when the website offers more attractive purchase rates for bulk purchase of products. Also bulk purchase can save on shipping costs. Further, parents who do not want their kids to make unnecessary purchases can make use of the non-authenticated item storing means to allow their children to select the products they wanted, at their own convenience without their parents presence and then later the parents can log in to the website and select the necessary items to purchase, and make the purchase. The embodiments of the invention also allow first-time users of the website to view and store items which can help to attract more users to the website, therefore more advertisers will be willing to put up their products for sale at the website which accordingly can result in generating more sales and income for the website. The embodiments of this invention also can help to attract impulse buyers to the website.

The present disclosure describes patentable subject matter with reference to certain illustrative embodiments. The drawings are provided to facilitate understanding of the disclosure, and may depict a limited number of elements for ease of explanation. Except as may be otherwise noted in this disclosure, no limits on the scope of patentable subject matter are intended to be implied by the drawings or the description herein. Variations, alternatives, and modifications to the illustrated embodiments may be included in the scope of protection available for the patentable subject matter which scope is only limited by the language in the appended claims.

We claim:

1. A method in an interactive medium for conducting commerce, said method comprising the steps of:
providing a website, the website adapted for electronic communication with a plurality of users;
enabling authentication of the one of the plurality of users on the website;
enabling one of the plurality of users to access the website and add items to a non- authenticated electronic shopping basket when the user is not authenticated on the website; and
providing on the website a plurality of authenticated electronic shopping baskets which are accessible by the plurality of users after successful authentication.

2. The method of claim 1, wherein once the one of the plurality of users is authenticated, the items in the non-authenticated electronic shopping basket will be automatically transferred into a first one of the plurality of authenticated electronic shopping basket.

3. The method of claim 2, wherein a second authenticated electronic shopping basket will be provided when items are added to the first one of the plurality of authenticated electronic shopping basket.

4. The method of claim 3, wherein when there are a plurality of authenticated electronic shopping baskets provided, items will be added to an active one of the plurality of authenticated electronic shopping baskets.

5. The method of claim 4, wherein only one authenticated electronic shopping basket can be active, and the authenticated electronic shopping basket can be made active by clicking on it or by clicking on “Previous” or “Next” button.

6. The method of claim 1, wherein the one of the plurality of authenticated users can copy and merge items between the plurality of authenticated electronic shopping baskets after the one of the plurality of users has successfully authenticated.

7. The method of claim 1, wherein the one of the plurality of authenticated users is able to view the status of the plurality of authenticated electronic shopping baskets and affect the state of the plurality of authenticated electronic shopping baskets; remove, add or change the quantity of items, and check out items for purchase.

8. The method of claim 7, wherein the one of the plurality of authenticated users can approve some of the items in the plurality of authenticated electronic shopping baskets for check out without affecting the rest of the items.

9. The method of claim 1, wherein a wish list can be used as an authenticated subsidiary basket for storing the one of the plurality of authenticated users' favourite items which can be transferred to an active authenticated electronic shopping basket for purchase by the user.

10. The method of claim 9, wherein items in the wish list may not be checked out.

11. A method in an interactive medium for conducting commerce, said method comprising the steps of:
a user accessing a website for conducting electronic commerce;
the user adding items into a non-authenticated electronic shopping basket before he authenticates himself on the website; and
the user adding items to a plurality of authenticated electronic shopping baskets when he has successfully authenticated himself, whereby the user can select each of the plurality of electronic shopping baskets for adding items to the electronic shopping baskets.

12. The method of claim 11, wherein once the one of the plurality of users is authenticated, the items in the non-authenticated electronic shopping basket will be automatically transferred into a first one of the plurality of authenticated electronic shopping basket.

13. The method of claim 12, wherein a second authenticated electronic shopping basket will be provided when items are added to the first one of the plurality of authenticated electronic shopping basket.

14. The method of claim 13, wherein when there are a plurality of authenticated electronic shopping baskets provided, items will be added to an active one of the plurality of authenticated electronic shopping baskets.

15. The method of claim 14, wherein only one authenticated electronic shopping basket can be active, and the authenticated electronic shopping basket can be made active by clicking on it or by clicking on “Previous” or “Next” button.

16. The method of claim 11, wherein the one of the plurality of authenticated users can copy and merge items between the plurality of authenticated electronic shopping baskets after the one of the plurality of users has successfully authenticated.

17. The method of claim 11, wherein the one of the plurality of authenticated users is able to view the status of the plurality of authenticated electronic shopping baskets and affect the state of the plurality of authenticated electronic shopping baskets; remove, add or change the quantity of items, and check out items for purchase.

18. The method of claim 17, wherein the one of the plurality of authenticated users can approve some of the items in the plurality of authenticated electronic shopping baskets for check out without affecting the rest of the items.

19. The method of claim 18, wherein the items checked out can be from one of the active or non-active authenticated electronic shopping baskets of the one of the plurality of users' choice with no interference to the rest of the plurality of authenticated electronic shopping baskets.

20. The method of claim 19, wherein the remaining items in the plurality of authenticated electronic shopping baskets can be stored for future use when the one of the plurality of users next authenticates himself.
